(19) United States
(12) Patent Application Publication
(10) Pub. No.: US 2016/0377888 A1
(43) Pub. Date: Dec. 29, 2016

(54) Using Subtractive Chromatic Modulation for Regulating Visual Acuity

(71) Applicant: Allan N. Hytowitz, Alpharetta, GA (US)

(72) Inventor: Allan N. Hytowitz, Alpharetta, GA (US)

(21) Appl. No.: 14/750,479

(22) Filed: Jun. 25, 2015

(51) Int. Cl. G02C 7/10

(52) U.S. Cl. CPC G02C 7/104; G02C 2202/16; G02C 2202/22

(57) ABSTRACT

Acuity is a function of the photoreceptors of the retina which combine their pixelized stimulation to create the perception of a contiguous image and use that stimulus to regulate the acuity focal length of the biological lens. That image perception is also modulated by the intensity of the light as a stimulus absorbed by those pixelized photoreceptors and, for most individuals, the color frequency of that light. The regulation of visual acuity is primarily determined by the comparative chromatic response of the cone photoreceptors in creating a response matrix to the relative chromatic intensity of the perceived light and using that response to regulate the focal length of the biological lens.

Sequential subtractive modulation (using selective tints and reduced luminance) of specific frequencies of light not only may be used to modulate acuity and the visual focal length, but the sequence of layers of subtractive modulation may be used to incrementally modulate and regulate that acuity focal length due to the specific focal lengths of each of the layers of chromatic tint.

### BACKGROUND

The eye as an optical system is a primary organ of the body for determining location and orientation. The primary components within the eye for responding to that stimulus of light are the photoreceptors. Rod photoreceptors are primarily responsive to the intensity of light. Cone photoreceptors are primarily sensitive to specific frequency ranges of light such as red (L-long), green (M-medium), and blue (S-short). Red (L) photoreceptors tend to have a primary sensitivity to light from 440 nm up to 680 nm with a peak at 564 nm. Green (M) photoreceptors tend to have a primary sensitivity to light from 440 nm up to 640 nm with a peak at 534 nm. Blue (S) photoreceptors tend to have a primary sensitivity to light from 360 nm up to 500 nm with a peak at 420 nm. As light passes through the lens of the eye, the ovoid shape and focal length of the lens is modulated by the stress from the muscles and cilia attached to it. That focal process also has a chromatic effect inherent in lenses due to frequencies of light being refracted (bent) by the lens at different angles reflective of, and proportional to, that optical frequency. That chromatic refraction not only results in determining the focus of light, but also results in those frequencies being focused at different sequential depths within the retina based upon their wavelength frequency. With a convex-type lens, such as what is typically found in the biological eye, blue (S) light is focused at a shorter distance than green (M) light, which is focused at a shorter distance than red (L) light. The point of optimum focus for an image is the acuity endpoint, which results from the aggregate stimulus of the cone photoreceptors.

Within the human eye, evolutionary tendencies have resulted in variances of the ratios of the red (L), green (M), and blue photoreceptors among genetic population groups. Despite the seemingly universal tendency for letter-based literacy, a significant percentage of the human gene pool continues to be preferential for detecting predators and game at a far distance. This is facilitated by a higher component ratio of red/green photoreceptors, which essentially has the retina adjust the focal length so that red is predominantly focused on the retina surface. That “Red-Focused Vision” tends to have a higher percentage of red (L) photoreceptors (75% red, 20% green, and 5% blue) whose ratio provides a more stable image for objects viewed at a distance. “Green-Focused Vision” has a lower percentage of red (L) photoreceptors (55% red, 40% green, and 5% blue) whose ratio provides a more stable image for objects viewed at closer distances.

With the advent of letter-based writing, whose use usually necessitates the decoding of a stable near-distance image, those individuals with “Green-Focused Vision” are able to have a more stable near-distance image due to their red/green photoreceptor ratio. The letter-based literacy effect of “Red-Focused Vision” however, is that those individuals frequently exhibit near-distance induced visual symptoms described as dyslexia, where viewing near image text produces an unstable, and more difficult to de-code, image. By using selective subtractive chromatic modulation to adjust the overall visual focal length for near-distance images, for individuals with “Red-Focused Vision,” that near-distance image visual stability may be significantly increased.

### APPLICATION

Acuity becomes a learned, autonomic response as the disparate cone photoreceptors respond to the focused image on the retina, but respond such that the net acuity accommodation has the blue, green, and red frequencies of light focused at incrementally longer focal length distances relative to the retina.

Subtractive modulation of the frequencies of light, however, results in that learned, autonomic response of the retina causing a shift in the overall net visual accommodative focal length of the lens. Because that subtractive modulation affects the chromatic focal length at specific focal distances, multiple layers of subtractive modulation (using selective tints and reduced luminance) with specific frequencies of light results in multiple reductions of the visual stimulus at incremental and specific focal length distances.

The specific combination of those multiple subtractive modulation layers (using selective tints and reduced luminance) can then be used to specifically modulate and regulate the overall visual focal length, and provide a more stable image at close viewing distances. Conversely, selective subtractive modulation can also be used to shift the focal length stability to be preferential for a stable image at further distances.

### BRIEF DESCRIPTION OF THE SEVERAL VIEWS OF THE DIAGRAMS:

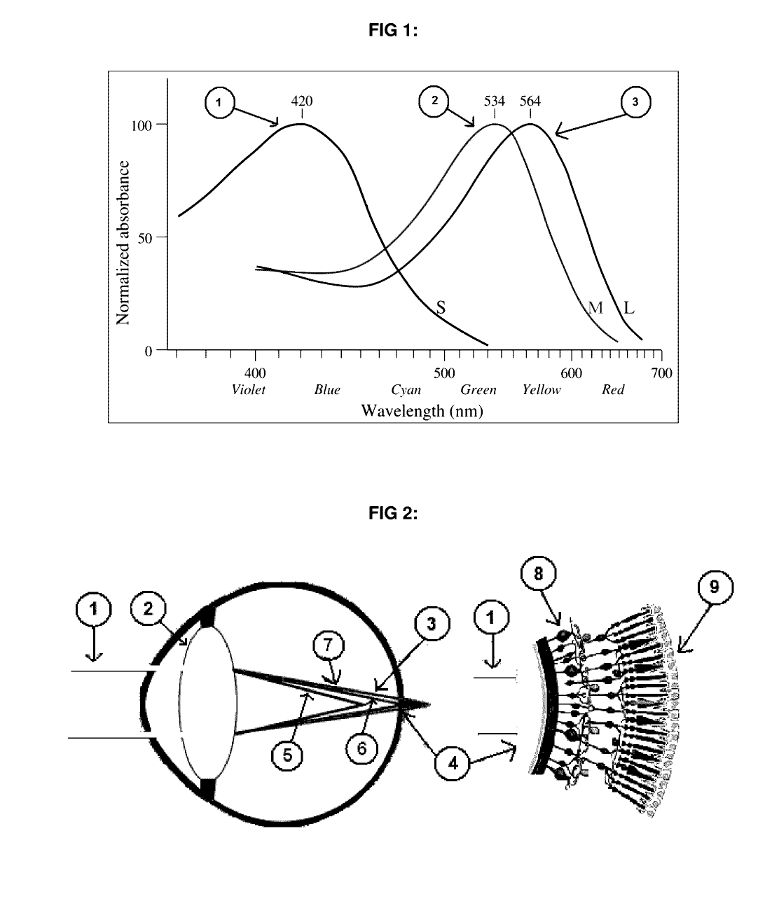

FIG. 1: visual photoreceptor response

Item 1—(S)—blue photoreceptor range

Item 2—(M)—Green photoreceptor range

Item 3—(L)—Red photoreceptor range

FIG. 2: “Green-Focused Vision” within the biological eye

Item 1—Rays of light

Item 2—Lens of the eye

Item 3—Net chromatic range for visible light focused on the retina with red at the furthest focal length behind the retina, green focused on the retina, and blue in front of the retina.

Item 4—Fovea location for S-M-L chromatic sensitive photoreceptors with a 55%/40% red/green ratio

Item 5—(S)—Blue—short wavelength of light

Item 6—(M)—Green—medium wavelength of light

Item 7—(L)—Red—long wavelength of light

Item 8—Layers of neural ganglia for signal processing

Item 9—Array of S-M-L photoreceptors

FIG. 3: “Red-Focused Vision” within the biological eye

Item 1—Rays of light

Item 2—Lens of the eye

Item 3—Net chromatic range for visible light focused on the retina with red at the furthest focal length focused on the retina, green focused in front of the retina, and blue focused even further in front of the retina.

Item 4—Fovea location for S-M-L chromatic sensitive photoreceptors with a 75%/20% red/green ratio

Item 5—(S)—Blue—short wavelength of light

Item 6—(M)—Green—medium wavelength of light

Item 7—(L)—Red—long wavelength of light

Item 8—Layers of neural ganglia for signal processing

Item 9—Array of S-M-L photoreceptors

FIG. 4: Green-Focused Vision with a non-chromatic optical refractive lens

Item 1—Rays of light

Item 2—Lens of the eye

Item 3—Net chromatic range for visible light focused on the retina with red at the furthest focal length behind the retina, green focused on the retina, and blue in front of the retina.

Item 4—Fovea location for S-M-L chromatic sensitive photoreceptors with a 55%/40% red/green ratio

Item 5—Non-chromatic optical refractive lens

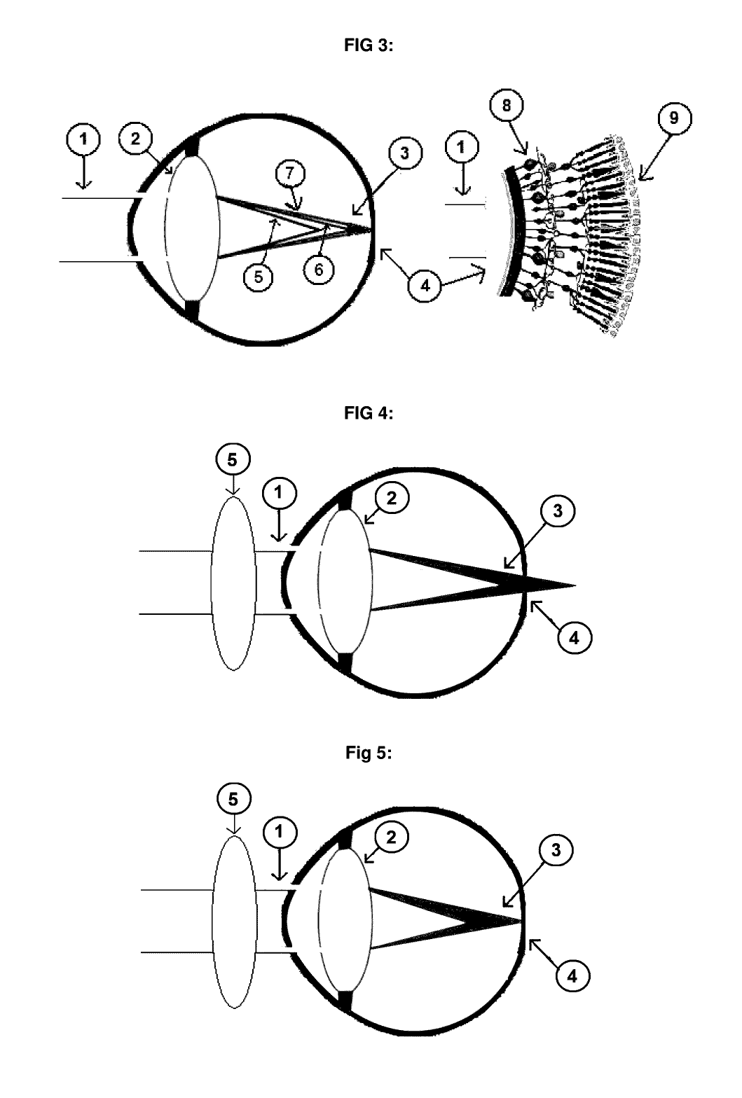

FIG. 5: Red-Focused Vision with a non-chromatic optical refractive lens

Item 1—Rays of light

Item 2—Lens of the eye

Item 3—Net chromatic range for visible light focused on the retina with red at the furthest focal length focused on the retina, green focused in front of the retina, and blue focused even further in front of the retina

Item 4—Fovea location for S-M-L chromatic sensitive photoreceptors with a 75%/20% red/green ratio

Item 5—Non-chromatic optical refractive lens

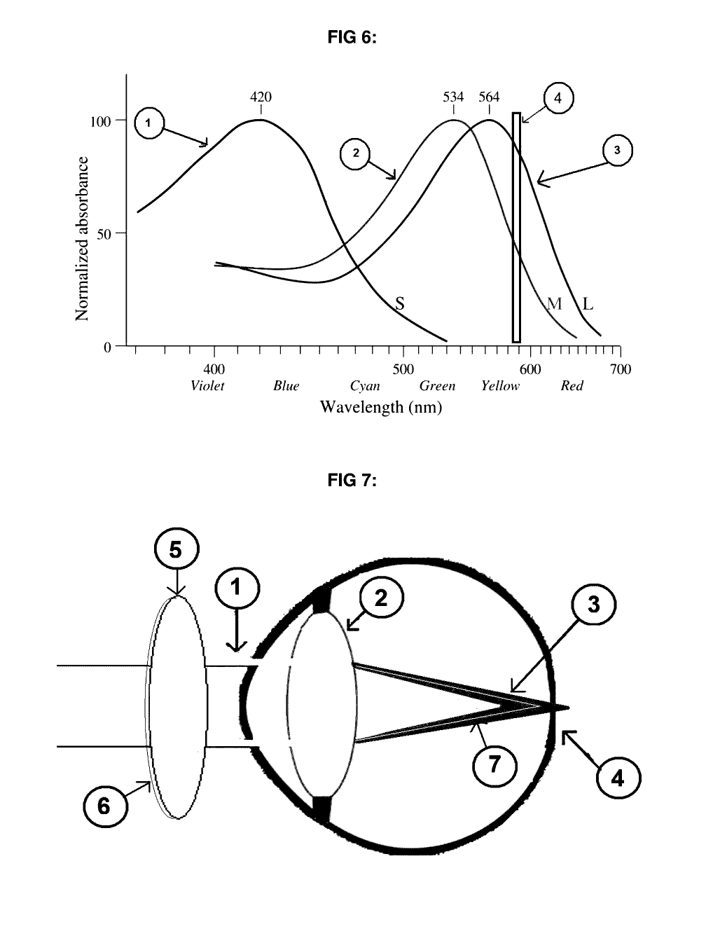

FIG. 6: Single long wavelength subtractive long wavelength chromatic modulation

Item 1—(S)—blue photoreceptor range

Item 2—(M)—Green photoreceptor range

Item 3—(L)—Red photoreceptor range

Item 4—Single long wavelength selective tint with reduced luminance

FIG. 7: Chromatic acuity modulation of Red-Focused Vision in response to a single long wavelength selective tint

Item 1—Rays of light

Item 2—Lens of the eye

Item 3—Net chromatic range for visible light focused on the retina with red at the furthest focal length focused slightly behind the retina, green focused in front of the retina, and blue focused even further in front of the retina

Item 4—Fovea location for chromatic sensitive photoreceptors.

Item 5—External optical lens

Item 6—Optical tint layer providing subtractive chromatic modulation

Item 7—Frequency effect of subtractive chromatic modulation

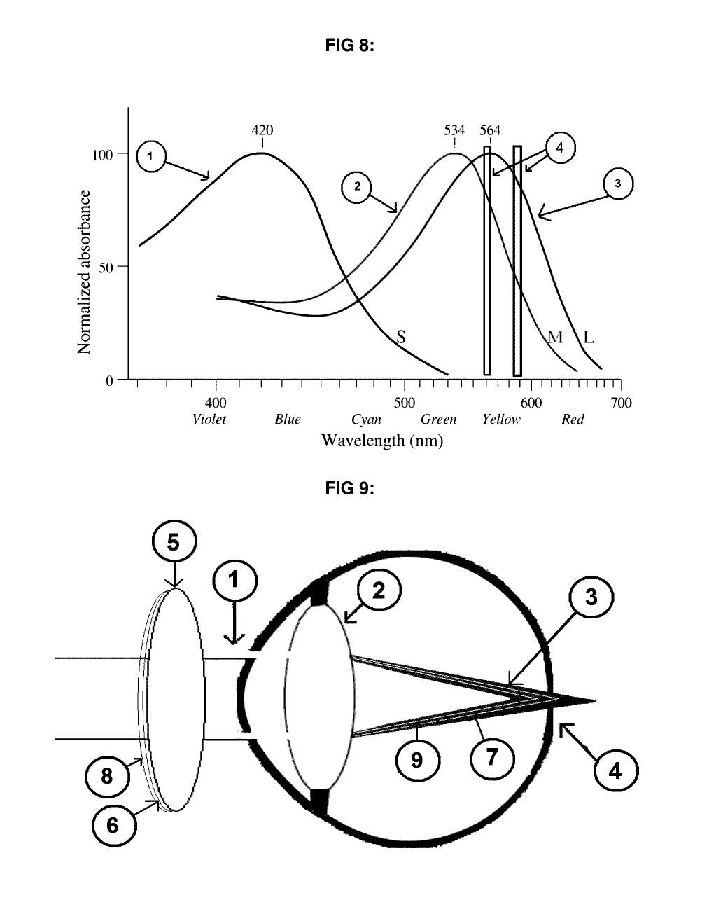

FIG. 8: Chromatic acuity modulation of Red-Focused Vision in response to a multiple long wavelength selective tint

Item 1—(S)—blue photoreceptor range

Item 2—(M)—Green photoreceptor range

Item 3—(L)—Red photoreceptor range

Item 4—Multiple long wavelength selective tints with reduced luminance

FIG. 9: Chromatic acuity modulation of Red-Focused Vision in response to a multiple long wavelength selective tint

Item 1—Rays of light

Item 2—Lens of the eye

Item 3—Net chromatic range for visible light focused on the retina with red at the furthest focal length focused slightly behind the retina, green focused in front of the retina, and blue focused even further in front of the retina

Item 4—Fovea location for chromatic sensitive photoreceptors.

Item 5—External optical lens

Item 6—Optical tint layer #1 providing subtractive chromatic modulation

Item 7—Frequency effect of subtractive chromatic modulation from tint layer #1

Item 8—Optical tint layer #2 providing subtractive chromatic modulation

Item 9—Frequency effect of subtractive chromatic modulation from tint layer #2

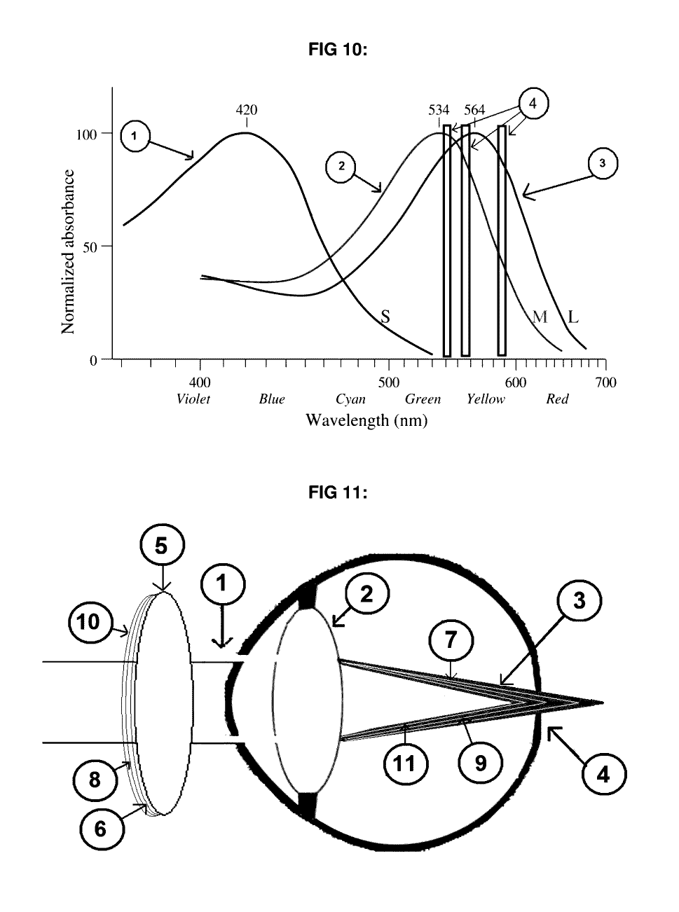

FIG. 10: Chromatic acuity modulation of Red-Focused Vision in response to a multiple long wavelength selective tint

Item 1—(S)—blue photoreceptor range

Item 2—(M)—Green photoreceptor range

Item 3—(L)—Red photoreceptor range

Item 4—Multiple long wavelength selective tints with reduced luminance

FIG. 11: Chromatic acuity modulation of Red-Focused Vision in response to a multiple long wavelength selective tint

Item 1—Rays of light

Item 2—Lens of the eye

Item 3—Net chromatic range for visible light focused on the retina with red at the furthest focal length focused slightly behind the retina, green focused in front of the retina, and blue focused even further in front of the retina

Item 4—Fovea location for chromatic sensitive photoreceptors.

Item 5—External optical lens

Item 6—Optical tint layer #1 providing subtractive chromatic modulation

Item 7—Frequency effect of subtractive chromatic modulation from tint layer #1

Item 8—Optical tint layer #2 providing subtractive chromatic modulation

Item 9—Frequency effect of subtractive chromatic modulation from tint layer #2

Item 10—Optical tint layer #2 providing subtractive chromatic modulation

Item 11—Frequency effect of subtractive chromatic modulation from tint layer #2

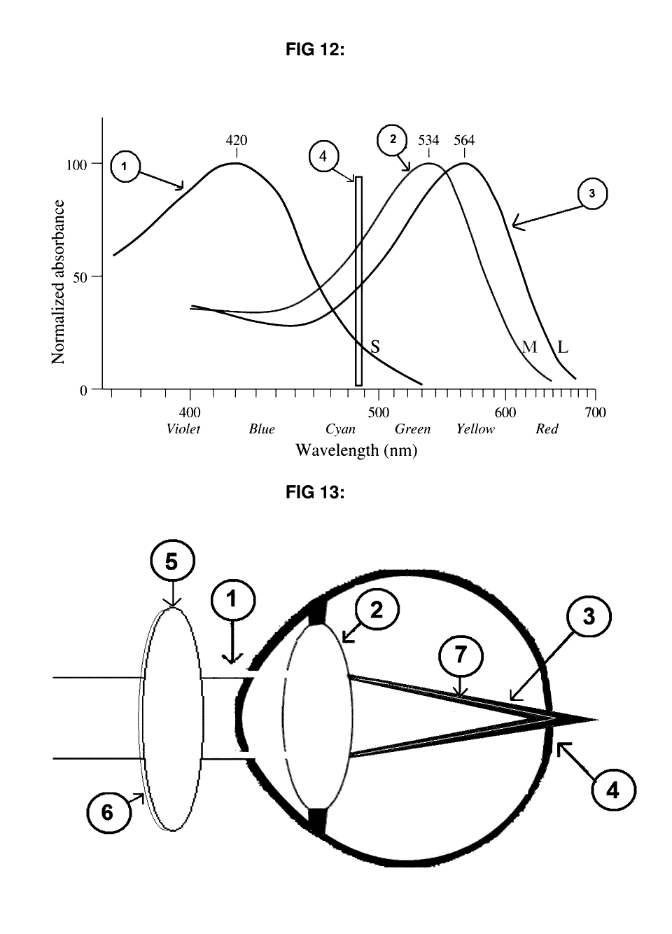

FIG. 12: Single short wavelength subtractive Green-Focused Vision chromatic modulation

Item 1—(S)—blue photoreceptor range

Item 2—(M)—Green photoreceptor range

Item 3—(L)—Red photoreceptor range

Item 4—Single short wavelength selective tint with reduced luminance

FIG. 13: Chromatic acuity modulation of Green-Focused Vision in response to a single short wavelength selective tint

Item 1—Rays of light

Item 2—Lens of the eye

Item 3—Net chromatic range for visible light focused on the retina with red at the furthest focal length focused slightly behind the retina, green focused in front of the retina, and blue focused even further in front of the retina

Item 4—Fovea location for chromatic sensitive photoreceptors.

Item 5—External optical lens

Item 6—Optical short wavelength tint layer providing subtractive chromatic modulation

Item 7—Frequency effect of short wavelength subtractive chromatic modulation

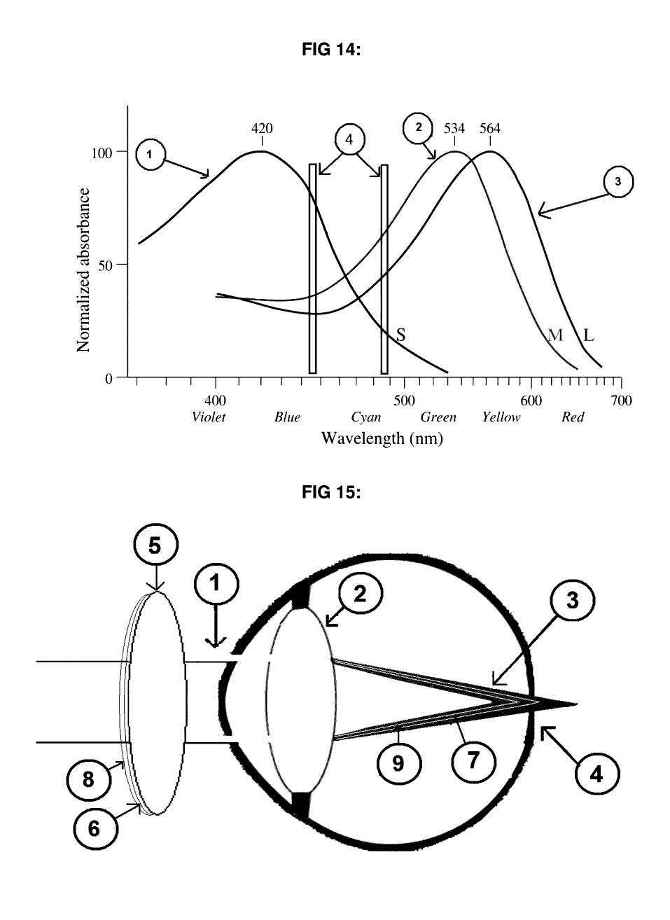

FIG. 14: Multiple short wavelength Green-Focused Vision subtractive chromatic modulation

Item 1—(S)—blue photoreceptor range

Item 2—(M)—Green photoreceptor range

Item 3—(L)—Red photoreceptor range

Item 4—Multiple short wavelength selective tints with reduced luminance

FIG. 15: Chromatic acuity modulation of Green-Focused Vision in response to a multiple short wavelength selective tint

Item 1—Rays of light

Item 2—Lens of the eye

Item 3—Net chromatic range for visible light focused on the retina with red at the furthest focal length focused slightly behind the retina, green focused in front of the retina, and blue focused even further in front of the retina

Item 4—Fovea location for chromatic sensitive photoreceptors.

Item 5—External optical lens

Item 6—Optical short wavelength tint layer #1 providing subtractive chromatic modulation

Item 7—Frequency effect of short wavelength #1 subtractive chromatic modulation

Item 8—Optical short wavelength tint layer #2 providing subtractive chromatic modulation

Item 9—Frequency effect of short wavelength #2 subtractive chromatic modulation

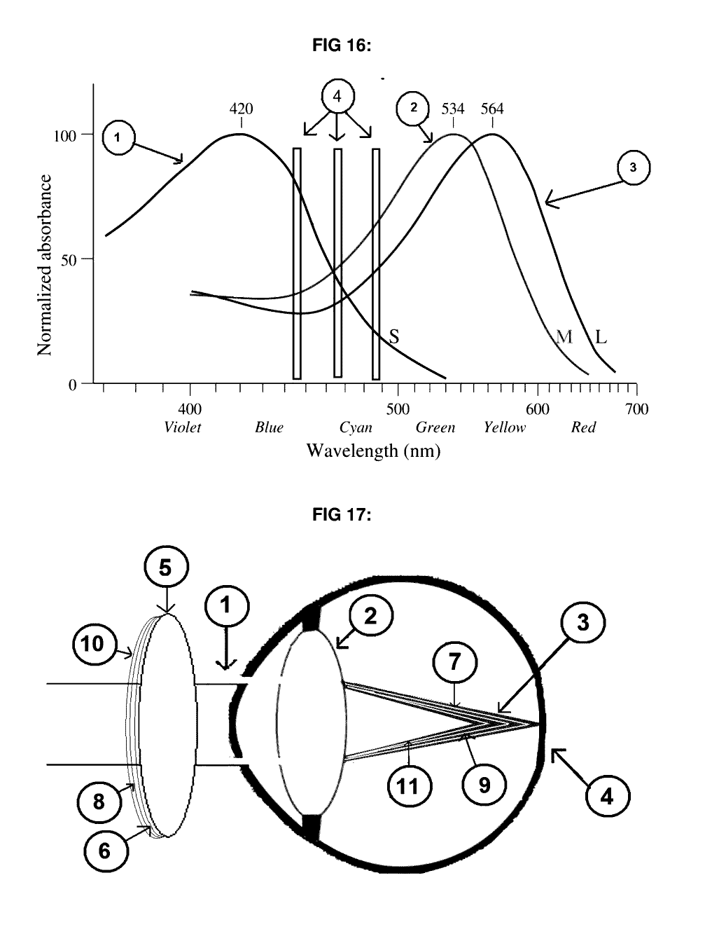

FIG. 16: Multiple short wavelength Green-Focused Vision subtractive chromatic modulation

Item 1—(S)—blue photoreceptor range

Item 2—(M)—Green photoreceptor range

Item 3—(L)—Red photoreceptor range

Item 4—Multiple short wavelength selective tints with reduced luminance

FIG. 17: Chromatic acuity modulation of Green-Focused Vision in response to a multiple short wavelength selective tint

Item 1—Rays of light

Item 2—Lens of the eye

Item 3—Net chromatic range for visible light focused on the retina with red at the furthest focal length focused slightly behind the retina, green focused in front of the retina, and blue focused even further in front of the retina

Item 4—Fovea location for chromatic sensitive photoreceptors.

Item 5—External optical lens

Item 6—Optical short wavelength tint layer #1 providing subtractive chromatic modulation

Item 7—Frequency effect of short wavelength #1 subtractive chromatic modulation

Item 8—Optical short wavelength tint layer #2 providing subtractive chromatic modulation

Item 9—Frequency effect of short wavelength #2subtractive chromatic modulation

Item 10—Optical short wavelength tint layer #3 providing subtractive chromatic modulation

Item 11—Frequency effect of short wavelength #3 subtractive chromatic modulation range for visible light focused on the retina with red at the furthest focal length focused slightly behind the retina, green focused in front of the retina, and blue focused even further in front of the retina

What is claimed is:

1. Using subtractive chromatic modulation of an image to reduce the intensity of a specific wavelength of light, or selected multiple wavelengths of light, will produce a controlled shift in the focal length of the lens and a can be used selectively increase the perception of visual stability of that image.

2. Because that subtractive modulation affects perception at a specific focal length within a biological lens, the sequence of a multiple layers of subtractive chromatic modulating tints becomes a factor in the overall chromatic modulation due to the chromatic response of both the cone photoreceptors and the color sensitive cells of the retina neural ganglia.

3. Selective use of specific subtractive modulating tints in layered in a specific sequence can in turn modulate the overall focal length of the biological lens to adjust the visual focal length and modulate the image stability.
